(19) United States
(12) Patent Application Publication
(10) Pub. No.: US 2022/0343372 A1
(43) Pub. Date: Oct. 27, 2022

(54) VIDEO PROCESSING METHOD AND DEVICE, ELECTRONIC APPARATUS, AND STORAGE MEDIUM

(71) Applicant: BEIJING DAJIA INTERNET INFORMATION TECHNOLOGY CO.,LTD., Beijing (CN)

(72) Inventors: Yinhui LI, Beijing (CN); Jialu LIU, Beijing (CN); Yun WANG, Beijing (CN); Xinyi YIN, Beijing (CN)

(21) Appl. No.: 17/858,495

(22) Filed: Jul. 6, 2022

Related U.S. Application Data
(63) Continuation of application No. PCT/CN2021/073395, filed on Jan. 22, 2021.

(30) Foreign Application Priority Data
Jan. 23, 2020 (CN) 202010076052.2

(51) Int. Cl. G06Q 30/02; G06F 16/78

(52) U.S. Cl. CPC G06Q 30/0276; G06Q 30/0271; G06F 16/7867

(57) ABSTRACT

A method for processing a video and a corresponding apparatus are provided. The method for processing the video includes determining a plurality of candidate commodities that will be recommended to a user, based on attribute information of the user and attribute information of a plurality of commodities to be promoted; sending recommendation information including the plurality of candidate commodities to a user terminal; receiving a selection instruction for a target commodity sent by the user terminal and a video created by the user for the target commodity, wherein the target commodity is selected by the user from the plurality of candidate commodities based on the recommendation information; and creating a promotional video by synthesizing sales information of the target commodity with the video.

### CROSS-REFERENCE TO RELATED APPLICATIONS

The present disclosure is a continuation of International Application No. PCT/CN 2021/073395, filed on Jan. 22, 2021, which is based upon and claims priority to Chinese Patent Application No. 202010076052.2 filed on Jan. 23, 2020, which is incorporated herein by reference in their entireties as a part of the present disclosure.

### TECHNICAL FIELD

The present disclosure relates to the technology field of video processing, and in particular to a method, an apparatus, an electronic device and storage medium for processing a video.

### BACKGROUND

Nowadays, with the rapid development of video technology, more and more users start to use and make videos, especially short videos that are very popular among users. Some video makers are sought after by huge audiences with their high-quality videos. As more and more commodities are promoted and successful by the help of video makers with high attention in video software (such as short video APPs), many merchants begin to seek such video makers to promote their commodities to achieve marketing purposes.

### SUMMARY

According to one aspect of the implementations of the present disclosure, a method for processing a video is provided. The method for processing the video includes: determining a plurality of candidate commodities that will be recommended to a user based on attribute information of the user and attribute information of a plurality of commodities to be promoted; sending recommendation information including the plurality of candidate commodities to a user terminal; receiving a selection instruction for a target commodity sent by the user terminal and a video created by the user for the target commodity, wherein the target commodity is selected by the user from the plurality of candidate commodities based on the recommendation information; and creating a promotional video by synthesizing sales information of the target commodity with the video.

According to another aspect of the implementations of the present disclosure, an electronic device is provided. The electronic device includes: a processor and a memory for storing instructions executable by the processor; wherein the processor is configured to: determine a plurality of candidate commodities that will be recommended to a user based on attribute information of the user and attribute information of a plurality of commodities to be promoted; send recommendation information including the plurality of candidate commodities to a user terminal; receive a selection instruction for a target commodity sent by the user terminal and a video created by the user for the target commodity, wherein the target commodity is selected by the user from the plurality of candidate commodities based on the recommendation information; and create a promotional video by synthesizing sales information of the target commodity with the video.

According to another aspect of the implementations of the present disclosure, a computer-readable storage medium is provided, when instructions in the storage medium are executed by a processor of an electronic device, the electronic device can execute the method for processing the video as described above.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated into and constitute a part of this specification, illustrate embodiments consistent with the present disclosure, and together with the description, serve to explain the principles of the present disclosure and do not unduly limit the present disclosure.

FIG. 1 is an application environment diagram illustrating a method for processing a video according to some implementations.

FIG. 2 is a flowchart illustrating a method for processing a video according to some implementations.

FIG. 3 is a flowchart illustrating a supplementary solution for creating and obtaining a promotional video by synthesizing sales information of a target commodity with a video, according to some implementations.

FIG. 4 is a schematic diagram illustrating the effect of a short video with promotion content according to some implementations.

FIG. 5 is a block diagram illustrating an apparatus for processing a video according to some implementations.

FIG. 6 is a block diagram illustrating an electronic device according to some implementations.

### DETAILED DESCRIPTION

In order to make those skilled in the art better understand the technical solutions of the present disclosure, the technical solutions in the implementations of the present disclosure will be clearly and completely described below with reference to the accompanying drawings.

It should be noted that the terms ‘first’, ‘second’ and the like in the description and claims of the present disclosure and the above drawings are used to distinguish similar objects, and are not necessarily used to describe a specific sequence or precedence order. It is to be understood that the data so used may be interchanged under appropriate circumstances such that the implementations of the disclosure described herein can be practiced in sequences other than those illustrated or described herein. The implementations described in the illustrative examples below are not intended to represent all implementations consistent with this disclosure. Rather, they are merely examples of apparatus and methods consistent with some aspects of the present disclosure as recited in the appended claims.

In the related art, in order to find a suitable video maker, most merchants select a target video maker by offline or by browsing personal information of the video makers on various platforms, and at the same time considering the compatibility between the video makers and the commodity, which makes the process of merchants finding the target video maker more tedious and costly. Also, sometimes video makers are less satisfied with the commodities that need to be promoted.

FIG. 1 is an application environment diagram illustrating a method for processing a video according to some implementations. The method for processing the video provided by the present disclosure can be applied to the application environment shown in FIG. 1. In the application environment, a terminal 102 communicates with a server 104 through a network. Specifically, when a user opens, in the terminal 102, a recommendation interface of commodities to be promoted, the server 104 determines a plurality of candidate commodities that will be recommended to the user based on attribute information of the user and attribute information of the commodity to be promoted, and sends recommendation information including the plurality of candidate commodities to the terminal 102, so as to be displayed to the user through the terminal 102. After the user selects a target commodity via the terminal 102, a related video can be created based on the target commodity, and the terminal 102 sends a corresponding selection instruction and the video to the server 104. Then, the server 104 synthesizes sales information of the target commodity with the video, so as to create a promotional video. It can be understood that the sales information of the target commodity will be displayed to the audience during the video play process, thereby achieving the purpose of promoting the commodity.

The terminal 102 can be, but is not limited to, various personal computers, notebook computers, smart phones, tablet computers and portable wearable devices, and the server 104 can be implemented by an independent server or a server cluster composed of multiple servers.

The present disclosure provides a method, an apparatus an electronic device and storage medium for processing a video, so as to at least solve the problem of poor commodity promotion effect in the related art.

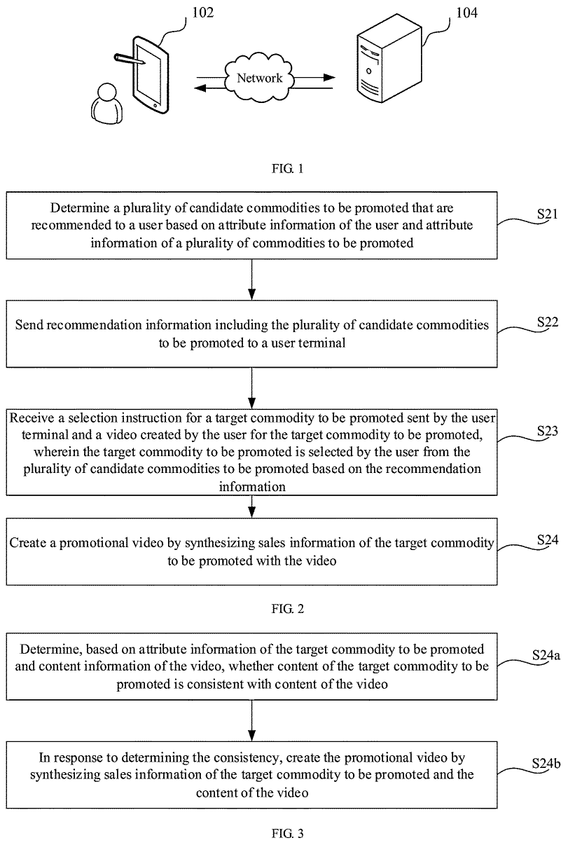

FIG. 2 is a flowchart illustrating a method for processing a video according to some implementations. The method for processing the video can be used in a server, as shown in FIG. 2, and includes the following steps.

In S21, a plurality of candidate commodities that will be recommended to a user are determined based on attribute information of the user and attribute information of the plurality of commodities to be promoted.

In S22, recommendation information including the plurality of candidate commodities is sent to a user terminal.

In S23, a selection instruction for a target commodity, sent by the user terminal, and a video created by the user for the target commodity are received, wherein the target commodity is selected by the user from the plurality of candidate commodities based on the recommendation information.

In S24, a promotional video is created by synthesizing sales information of the target commodity with the video.

Among them, the user may be a video maker. The video can be a short video or a long video. Correspondingly, the video maker may include a user who shoots short videos, a user who create long videos, and so on. Among them, some users are called a top video maker due to his or her high attention. Usually, the top video maker is more likely to sell a larger number of commodities than ordinary users.

In some implementations, the attribute information of the user includes one or more of basic attribute information of the user, a type of historical short videos uploaded by the user, the number of times the user browses commodities, and attribute information of commodities that have been promoted by the user. The attribute information of each of the commodities to be promoted includes one or more of basic attribute information of the commodity and applicable attribute information of the commodity. In some implementations, the basic attribute information of the user includes information such as gender, age, identity, and preference. The basic attribute information of the commodity includes information such as brand, model, style, and color. The applicable attribute information of the commodity includes applicable gender, applicable age, applicable identity and other information.

In some implementations, the attribute information of the user can be obtained based on the input of the user on a terminal used by the user. The attribute information of the commodity to be promoted can be obtained based on the input of the merchant on a terminal used by the merchant. The attribute information of the user and the attribute information of each of the commodities to be promoted can be uploaded to the server for storage. After obtaining the attribute information of the user and the attribute information of the plurality of commodities to be promoted, the server performs matching based on the attribute information of the user and the attribute information of the plurality of commodities to be promoted, thereby recommending the candidate commodities for the user, and send, to the user terminal, the recommendation information including the candidate commodities, so as to display, via the user terminal, the candidate commodities, so as to facilitate the user to select a target commodity on his or her terminal, and then the user terminal generates a selection instruction based on the selected target commodity and uploads it to the server. In addition, the terminal can also automatically recommend, according to a default recommendation mechanism, to the user the commodities to be promoted that are more in line with the user itself. The terminal may also display, according to a commodity category autonomously selected by the user, commodities to be promoted belonging to the category. In this way, the user can select the target commodity in the terminal used by the user.

After that, the user can create or shoot a short video based on the target commodity that selected by the user and perform the uploading. The server receives the selection instruction and the corresponding video sent by the terminal, and creates a promotional video by synthesizing the sales information of the target commodity with the video. In some implementations, in order to improve the visualization effect and facilitate audiences to quickly view the specific information of the commodity, the sales information of the commodity is packaged into a commodity entry in the form of a commodity card. In this way, the audience can enter a commodity detail page by clicking on the commodity entry, so as to know the specific information of the commodity in more detail.

The method for processing the video mentioned above first obtains the plurality of commodities to be promoted that are recommended to the user based on the attribute information of the user and the attribute information of the commodities to be promoted, and then obtains the target commodity selected by the user and the video created for the target commodity, and finally creates the promotional video by bringing sales information of the target commodity into the video. The present disclosure recommends, to the user, commodities to be promoted in consideration of an association degree between the user and commodities, which is beneficial for recommending commodities to be promoted with higher association degree to users, and improves the user's satisfaction with the commodities to be promoted. In addition, the sales information is automatically integrated into the video created by the user, and the user does not need to enter the commodity information personally to promote the commodity, and the audience can understand the displayed commodity information in time while watching the video, which makes the displaying of the commodity information more intuitive and improves the user promotion efficiency and the promotion effect of the commodity.

In some implementations, the method for processing the video involves possible implementations of creating the promotional video by synthesizing the sales information of the target commodity with the video. In the above-mentioned implementations, the creating the promotional video by synthesizing the sales information of the target commodity with the video may include the following steps:

acquiring the sales information of the target commodity, a display time and a display position of the sales information in the video;

determining a display mode of the target commodity in the video based on the sales information, the display time and the display position; and

creating the promotional video based on the display mode.

Among them, the sales information of the commodity includes commodity pictures, commodity names, sold quantities and sales prices. The display time refers to time information when the sales information of the commodity is displayed in the video, and includes a commodity start display time, a commodity end display time, and commodity display duration. The display position refers to position information where the sales information of the commodity is displayed in the video. In some implementations, the display position may be a position set at the lower left corner of the video, or may be a position set at the lower right corner of the video.

In some implementations, the server acquires the sales information such as the commodity pictures, the commodity name, and the sales price of the target commodity, and acquires the display time and the position of the sales information set in the video, thereby determining the display mode that the target commodity is displayed in the video. Based on this display mode, the sales information of the target commodity is integrated into the video created by the user, and finally the promotional video can be obtained. It can be understood that when the promotional video is played, it can be displayed according to the set display time and display position, so as to realize the effect of browsing the commodities while watching the video.

FIG. 3 is a flowchart illustrating a supplementary solution for creating and obtaining a promotional video by synthesizing sales information of a target commodity with a video, according to some implementations. The method for creating the promotional video can be applied to a server. Referring to FIG. 3, in some implementations, the method for creating the promotional video may include the following steps.

In S24a, according to attribute information of the target commodity and content information of the video, it is determined whether content of the target commodity is consistent with content of the video.

In S24b, in response to the content of the target commodity being consistent with the content of the video, the promotional video is created by synthesizing the sales information of the target commodity and the video.

In some implementations, the attribute information of the target commodity includes information such as brand, model, and style, etc. The content information of the video includes commodity information appearing in the video, and further includes information such as brand, model, style, color, and the like. It can be understood that the server determines whether the target commodity is consistent with the content of the short video according to a matching degree between the attribute information of the target commodity and the content information of the video, and the matching degree can represent the association between the attribute information of the target commodity and the content information of the video. In some implementations, the matching degree between the attribute information of the target commodity and the content information of the short video can be calculated, and the matching degree can be a numerical value. In response to the numerical value being greater than or equal to a preset value, it is indicated that the target commodity has a strong association with the content of the short video, and it can be determined that the target commodity is consistent with the content of the short video. Conversely, in response to the numerical value being less than the preset value, it is indicated that the target commodity has a weak association with the content of the short video, and it can be determined that the target commodity is inconsistent with the content of the short video. For example, in the case of the attribute information of the target commodity including brand A and children's clothing, in response to detecting that brand A and children's clothing, etc. are exist in the short video, it is determined that the target commodity is consistent with the content of the short video. In response to detecting that the video contains content such as brand B, elderly clothing, etc., it is determined that the target commodity is seriously inconformity with the content of the short video. At this time, it is determined that the target commodity is inconsistent with the content of the short video. In response to the content of the target commodity being consistent with the content of the short video, the server synthesizes the sales information of the target commodity with the video to create the promotional video.

In some implementations, the server may generate a commodity entry in the short video, and display the information such as commodity pictures, a commodity name, sold quantity, and selling price in the commodity entry. In this way, when the short video is played on the short video detail page of the terminal used by the audience, the terminal can display the commodity entry according to the above time, position and display mode, wherein the commodity entry information carried in the short video includes: commodity pictures, a commodity name, sold quantity, a selling price and other information. Based on this, the audience can determine whether to buy the commodity according to the user's explanation and propaganda for the commodity, and the audience can buy the same commodity at any time on the short video page, thus reducing the cost of the audience to find the commodity and improving the purchase efficiency.

In some implementations, the acquiring the display time of the sales information of the target commodity in the video includes various implementations, and now the following are listed.

Implementation 1: acquiring an appearance time of the target commodity in the video, determining a start display time of the target commodity based on the appearance time, and determining the display time of the commodity based on the start display time and an end time of the video.

In this implementation, the display time of the commodity is determined based on the time duration between the commodity start display time and the video end time, so as to increase the appearance time duration of the sales information of the target commodity, thereby improving the promotion effect.

Implementation 2: acquiring a start time and an end time of the video, and determining the display time of the commodity based on the start time and the end time.

In some implementations, the display time of the commodity is determined based on the time duration between the start time and the end time, to further increase the appearance duration of the sales information of the target commodity, thereby further improving the promotion effect.

Implementation 3: acquiring a preset start display time and a preset end display time of the target commodity in the video, and determining the display time of the commodity based on the preset start display time and the preset end display time.

In some implementations, the display time of the commodity is determined based on the time duration between the preset start display time and the preset end display time set via the system by default or autonomously set by the user, which is suitable for different application requirements and improves the flexibility of display.

In order to improve the fit between the video and the target commodity, in some implementations, the acquiring the sales information of the target commodity, and the display time and the display position of the sales information in the video include the following steps:

obtaining an association degree between the target commodity and each frame image in the video by analyzing the attribute information of the target commodity and the content information of the video;

selecting multiple frame images of which the association degrees satisfy a preset association degree condition; and

determining the display time based on respective appearance time of the multiple frame images.

In some implementations, the server extracts an attribute feature corresponding to the attribute information of the target commodity, and extracts a content feature corresponding to the content information of the video, and determines the association degree between the target commodity and each frame image according to the attribute feature and the content feature. For example, the association score between the target commodity and each frame image is calculated. Furthermore, the server selects the appearance time of the multiple frame images whose association degree satisfy the preset association degree condition, and determines it as the display time of the sales information of the target commodity. In some implementations, the appearance time of multiple frame images that are continuous and have an association degree greater than the preset association degree may be selected as the display time of the sales information.

Furthermore, in some exemplary implementations, the determining the display time according to the appearance time of the multiple frame images includes: determining the display time based on the appearance time of a first target frame image in which the target commodity is appeared for the first time among the multiple frame images; or determining the display time based on the appearance time of a second target frame image with a highest association degree among the multiple frame images.

It can be understood that in the video, when the target commodity is appeared for the first time, the sales information of the target commodity is displayed together. For example, when the promoted commodity is appeared for the first time in the X frame or X second of the video, an advertisement card containing the sales information is displayed at the same time. In addition, the image with the highest association degree is selected from all association degrees corresponding to all frame images, that is, the second target frame image. When the second target frame image appears, the sales information of the target commodity will be displayed together, which will help to improve the fit between the video and the commodity, increase the audience's recognition degree of the commodity to be promoted, thereby improving the user's viewing experience and enhancing the promotional effect.

In some implementations, the sales information of the commodity can be displayed when the video image has a higher degree of association with the commodity. By setting a specific display time of the commodity, the purpose of promoting the commodity to users in a targeted manner can be achieved, which is beneficial to the promotional effect of the commodity.

In some implementations, the attribute information of the user includes basic attribute information of the user and the type of historical short videos uploaded by the user. In the above implementations, the determining the candidate commodity to be promoted that are recommended to the user according to the attribute information of the user and the attribute information of the commodity to be promoted may include the following steps:

obtaining a matching score between the user and each of the plurality of commodities based on the basic attribute information of the user, the type of historical short videos uploaded by the user, and the attribute information of the plurality of commodities;

determining the plurality of candidate commodities based on commodities whose matching scores satisfy a preset score conditions.

In some implementations, the server matches the basic attribute information of the user and the type of historical short videos uploaded by the user with the attribute information of the plurality of commodities to be promoted, and obtains the matching score between the user and each of the plurality of commodities to be promoted. After that, the server selects the commodities to be promoted whose matching scores satisfy the preset score condition, and determines them as the plurality of candidate commodities that will be recommended through the user terminal to the user. In some implementations, the server selects commodities to be promoted with matching scores greater than a preset score as candidate commodities, or based on the magnitudes of multiple matching scores, the server selects, in descending order, the commodities to be promoted whose matching scores are at the top and satisfy a preset number of commodities as candidates commodities to be promoted.

In this implementation, by establishing the association between the short video type and the commodity to be promoted, the obtained recommendation result has a higher matching degree with the user's short video style, which improves the recommendation accuracy and is beneficial to the user's promotional effect.

In some implementations, the attribute information of the user further includes the number of times that the user browses commodities. In the above implementation, the determining the candidate commodities that will be recommended to the user according to the attribute information of the user and the attribute information of the commodity to be promoted may include the following steps:

determining preference information of the user based on the basic attribute information of the user, the type of historical short videos uploaded by the user, and the number of times that the user browses commodities;

determining a similarity between the user and each of the plurality of commodities based on the preference information of the user and the attribute information of the plurality of commodities; and

selecting the commodities whose similarity satisfy a preset similarity condition, and determining the plurality of candidate commodities based on the selected commodities.

In some implementations, the server constructs the preference vector of the user according to the basic attribute information of the user, the type of historical short videos uploaded by the user, and the number of times the user browses the commodities, and expresses the attribute information of the plurality of commodities to be promoted as the commodity feature vector, determines the similarity between the user and each of the plurality of commodities to be promoted by calculating a cosine distance between the preference vector of the user and the commodity feature vector, and then selects the commodities to be promoted whose similarity meet the preset similarity condition and determines them as the plurality of candidate commodities that will be recommended via the user terminal to the user. In some implementations, the server selects commodities to be promoted whose similarity is greater than a preset threshold as candidate commodities, or based on magnitudes of multiple similarities, the server selects, in descending order, the commodities to be promoted whose similarity are at the top and meets a preset number as candidate commodities.

In some implementations, by considering multiple factors to obtain the recommendation result, the accuracy of the recommendation can be further improved.

In some implementations, the attribute information of the user further includes attribute information of commodities that have been promoted by the user. In the above implementations, the determining the plurality of candidate commodities that will be recommended to the user based on the attribute information of the user and the attribute information of the plurality of commodities to be promoted may include the following steps:

matching a basic attribute tag based on the basic attribute information of the user;

matching a video type tag based on a type of historical short videos uploaded by the user;

matching a first commodity attribute tag based on attribute information of commodities that have been promoted by the user;

matching a second commodity attribute tag based on attribute information of the commodities to be promoted;

determining a user feature vector based on the basic attribute tag, the video type tag and the first commodity attribute tag, and determining respective feature vectors of the commodities to be promoted based on the second commodity attribute tag;

calculating respective distances between the user feature vector and the plurality of feature vectors of the commodities to be promoted by using a content-based recommendation algorithm, and selecting the commodities to be promoted whose distances meet a preset distance condition and determining them as the plurality of candidates commodities to be promoted that are recommended to the user. In some implementations, the server selects the commodities to be promoted whose distances are greater than a preset distance as the candidate commodities.

In some implementations, the attribute information of the commodities that have been promoted by the user is further added as a consideration factor for the recommendation, so that the recommendation result is closer to the commodity that the user wants to promote, and the satisfaction of the user is improved. In addition, by using the tag method, the amount of calculation is lower and the calculation rate is faster, so the recommendation efficiency is higher.

In some implementations, the number of short videos uploaded by the user is multiple. Specifically, users can upload multiple advertising short videos for multi-dimensional promotion and continuous delivery of commodities, so as to attract more audiences to see them and achieve a matrix promotion model.

Implementations for practical application scenarios are described in detail below. In the short video platform, there are many video makers. Today, more and more brands use video makers to promote commodities and brands. As an implementation, for a new video maker, or a video maker who has only purchased or browsed some commodities, the server will recommend the commodities to be promoted for the video maker based on the basic attribute information of the video maker and the applicable attribute information of the commodities. For example, if a video maker is a boy and 20 years old, and he likes watches, then, based on the aforementioned information of the video maker, it is matched with the commodities such as watches suitable for boys and teenagers. In some implementations, the server will use the matrix factorization to improve the CF algorithm, analyze the relationship between the basic attribute information of the video maker and the applicable attribute information of the commodities, and obtain the potential association between the video maker and the commodities to be promoted through the matrix factorization, so as to fill in missing values in the previous matrix to get the commodities to be promoted that are recommended for video makers.

As another implementation, for a video maker who has created short video works, the server will, based on the basic attribute information of the video maker, the type of historical short videos uploaded by the video maker, and the applicable attribute information of the commodities, and further based on collaborative filtering algorithm, recommend commodities to be promoted with high similarity for the video maker. For example, the system further obtains type tags of historical short video works already uploaded by the video maker. For example, if a video maker is a female and 22 years old, and 60% of her uploaded short video works are in the beauty category, then the server will recommend popular commodities of the beauty category, so as to improve the accuracy of commodity promotion. Further, the server will also recommend commodities belonging to a similar category to the beauty category (for example, skin care category) for the video maker. In some implementations, the server will preferentially recommend to the video maker the commodity to be promoted with the highest sales quantity in the above commodity category.

In some implementations, the video maker can also actively select the commodity category, so as to select the commodity that he or she wants to promote.

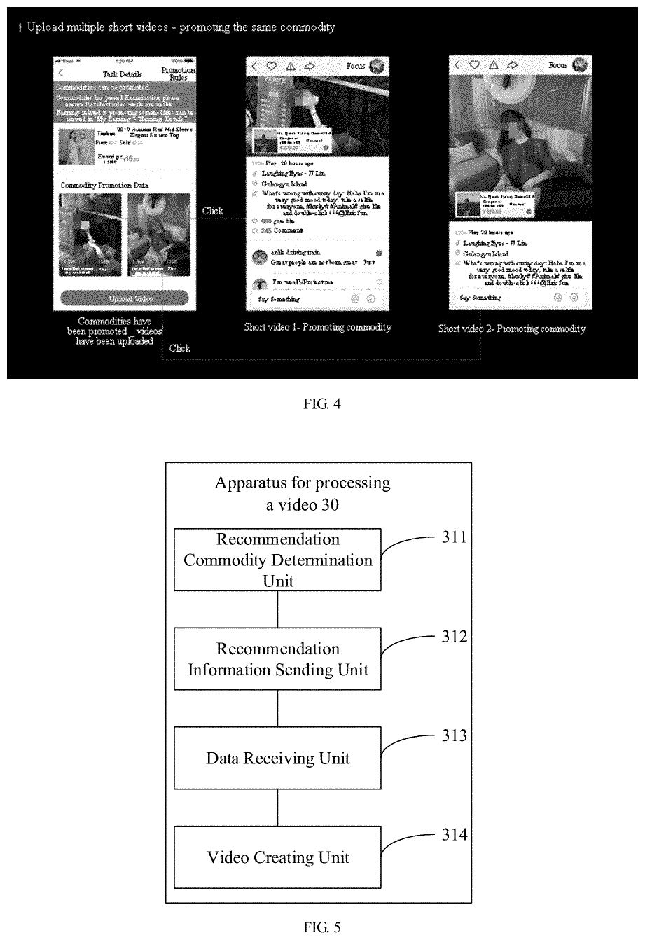

FIG. 4 is a schematic diagram illustrating the effect of a short video with promotion content according to some implementations. The video maker shoots or uploads one or more short videos after he has selected the commodity to be promoted. The server brings the information of the commodities to be promoted into the short videos to form short videos with promoted content, as shown in FIG. 4. In this way, fans can determine whether to buy the commodity according to the video maker's explanation and propaganda of the commodity. Furthermore, fans can buy the same commodity promoted by the video maker at any time on the short video page corresponding to the video maker that they like, thereby reducing the cost of searching for commodities and improving purchasing efficiency. For example, for a piece of clothing, the video maker can share the daily wearing habits, or the usual shoot spots, or recommend interesting shoot scenic spots, etc., so that consumers will not think that they are selling a commodity bluntly, but will think of chatting as a way to make friends. When recommending the required commodities according to the needs of consumers, it can not only quickly and accurately allow consumers to buy the commodities they want, but also leave a good overall impression, which is conducive to increasing the repurchase rate and reducing the return rate. When video makers promote commodities, they can also use operations such as comments and forwarding to interact with consumers more, increase the sense of intimacy with consumers, and greatly benefit the promotion effect of commodities.

FIG. 5 is a block diagram illustrating an apparatus for processing a video according to some implementations. The apparatus 30 includes a recommendation commodity determination unit 311, a recommendation information sending unit 312, a data receiving unit 313 and a video creating unit 314.

The recommendation commodity determination unit 311 is configured to determine a plurality of candidate commodities that will be recommended to a user based on attribute information of the user and attribute information of a plurality of commodities to be promoted.

The recommendation information sending unit 312 is configured to send recommendation information including the plurality of candidate commodities to a user terminal.

The data receiving unit 313 is configured to receive a selection instruction for a target commodity sent by the user terminal and a video created by the user for the target commodity, wherein the target commodity is selected by the user from the plurality of candidate commodities based on the recommendation information.

The video creating unit 314 is configured to create a promotional video by synthesizing sales information of the target commodity with the video.

The above apparatus for processing the video first obtains a plurality of commodities to be promoted recommended to the user according to the attribute information of the user and the attribute information of the commodities to be promoted, then obtains the target commodity selected by the user and the videos created for it, and finally the promotional video is produced by substituting the sales information of the target commodity into the video. The present disclosure eliminates the need for merchants to spend a lot of money to find suitable video creating users (such as video makers) to help them promote commodities, reduces the labor cost of merchants, and at the same time, considers the association degree between users and commodities, so as to recommend the commodities to be promoted to the user, which are conducive to recommending more relevant commodities to be promoted to the user, and improving users' satisfaction with the promoted commodities. In addition, the sales information is automatically integrated into the video created by the user, and the user does not need to enter the commodity information to promote it, and the audience can understand the information of the displayed commodity in time while watching the video, which makes the user's understanding of the commodity information more intuitive and improves, and improves the user promotion efficiency and commodity promotion effect.

In some of these implementations, the video creating unit 314 is specifically configured to acquire the sales information of the target commodity, a display time and a display position of the sales information in the video; determine a display mode of the target commodity in the video based on the sales information, the display time and the display position; and create the promotional video based on the display mode.

In some of these implementations, the video creating unit 314 is specifically configured to acquire an appearance time of the target commodity in the video, determine a start display time of the target commodity based on the appearance time, and determine the display time based on the start display time and an end time of the video; or acquire a start time and an end time of the video, and determine the display time based on the start time and the end time; or acquire a preset start display time and a preset end display time of the target commodity in the video, and determine the display time based on the preset start display time and the preset end display time.

In some of these implementations, the video creating unit 314 is specifically configured to obtain an association degree between the target commodity and each frame image in the video by analyzing the attribute information of the target commodity and content information of the video; select multiple frame images of which the association degrees satisfy a preset association degree condition; and determine the display time based on respective appearance time of the multiple frame images.

In some of these implementations, the video creating unit 314 is specifically configured to determine the display time based on the appearance time of a first target frame image in which the target commodity is appeared for a first time among the multiple frame images; or determine the display time based on the appearance time of a second target frame image with a highest association degree among the multiple frame images.

In some of these implementations, the video creating unit 314 is specifically configured to determine, based on the attribute information of the target commodity and content information of the video, whether content of the target commodity is consistent with content of the video; and in response to the content of the target commodity being consistent with the content of the video, creating the promotional video by synthesizing the sales information of the target commodity with the video.

In some of these implementations, the attribute information of the user includes the basic attribute information of the user and the type of historical short videos uploaded by the user; and the recommendation commodity determination unit 311 is specifically configured to obtain a matching score between the user and each of the plurality of commodities based on the basic attribute information of the user, the type of the historical short videos uploaded by the user, and the attribute information of the plurality of commodities; and select the commodities of which the matching scores satisfy a preset score conditions, and determine the plurality of candidate commodities based on the selected commodities.

In some of these implementations, the attribute information of the user further includes the number of times that the user browses commodities; and the recommendation commodity determination unit 311 is specifically configured to determine preference information of the user based on the basic attribute information of the user, the type of historical short videos uploaded by the user, and the number of times that the user browses commodities; determine a similarity between the user and each of the plurality of commodities based on the preference information of the user and the attribute information of the plurality of commodities; and select the commodities of which the similarities satisfy a preset similarity condition, and determine the plurality of candidate commodities based on the selected commodities.

In some of these implementations, the attribute information of the user further includes attribute information of the commodities that have been promoted by the user, and the recommendation commodity determination unit 311 is specifically configured to match a basic attribute tag based on the basic attribute information of the user; match a video type tag based on the type of historical short videos uploaded by the user; match a first commodity attribute tag based on attribute information of commodities that have been promoted by the user; match a second commodity attribute tag based on the attribute information of the plurality of commodities to be promoted; determine a user feature vector based on the basic attribute tag, the video type tag and the first commodity attribute tag, and determine respective feature vectors of the plurality of commodities to be promoted based on the second commodity attribute tag; calculate respective distances between the user feature vector and a plurality of feature vectors of the commodities to be promoted by using a content-based recommendation algorithm, and select the commodities to be promoted of which the distances satisfy a preset distance condition and determine the selected commodities as the plurality of candidate commodities that will be recommended to the user.

Regarding the apparatus in the above-mentioned implementations, the specific manner in which each module performs the operation has been described in detail in the implementations of the method, and will not be described in detail here.

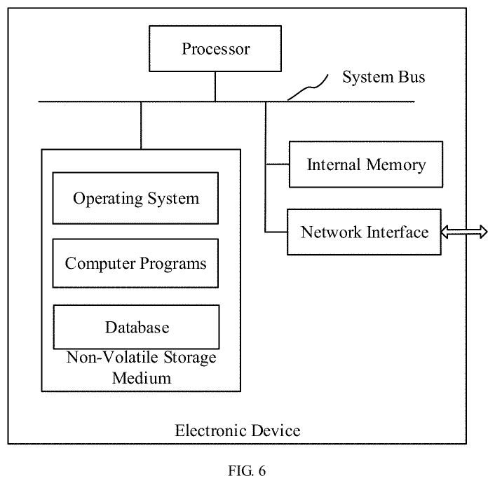

FIG. 6 is a block diagram illustrating an electronic device according to some implementations. The electronic device may be a server. The electronic device includes a processor, a memory, a network interface and a database connected by a system bus. Among them, the processor of the electronic device is used to provide computing and controlling capabilities. The memory of the electronic device includes a non-volatile storage medium and an internal memory. The non-volatile storage medium stores an operating system, computer programs, and a database. The internal memory provides an environment for the execution of the operating system and computer programs in the non-volatile storage medium. The network interface of the electronic device is used to communicate with an external terminal through a network connection. The computer programs, when executed by a processor, implement a method for processing a video.

Those skilled in the art can understand that the structure shown in FIG. 6 is only a block diagram of a partial structure related to the solution of the present disclosure, and does not constitute a limitation on the computer equipment to which the solution of the present disclosure is applied. The specific computer equipment includes more or fewer components than shown in the figures, or combines certain components, or has a different arrangement of components.

In some implementations, an electronic device is provided, comprising:

a processor;

a memory for storing instructions executed by the processor;

wherein, the processor is configured to execute the instructions to implement the method for processing the video described in the above implementations.

The above electronic device matches the attribute information of the target commodity with the content information of the short video, so as to determine the display information of the target commodity in the short video, so that when the short video is playing, the target commodity can be displayed based on the display information. Therefore, the audience can also understand the displayed commodity information while watching the short video, which makes the user's understanding of the commodity information more intuitive, thereby improving the promotion effect of the commodity.

In some implementations, a storage medium including instructions, such as a memory including instructions, is also provided, and the instructions can be executed by the processor of the apparatus to complete the method for processing the video described in the foregoing implementations. In some implementations, the storage medium may be a non-transitory computer-readable storage medium. For example, the non-transitory computer-readable storage medium may be read only memory (ROM), random access memory (RAM), CD-ROM, magnetic tape, floppy disk, and optical disk data storage devices, etc.

In some implementations, there is provided a computer program product comprising computer programs stored in a readable storage medium, when at least one processor of a device reads the computer programs for the readable storage medium and executes the computer programs, the method for processing the video in any one of the implementations of the first aspect is implemented.

All the implementations of the present disclosure can be implemented independently or in combination with other implementations, which are all regarded as the protection scope required by the present disclosure.

Other implementations of the present disclosure will readily occur to those skilled in the art upon consideration of the specification and practice of the disclosure disclosed herein. The present disclosure is intended to cover any variations, uses, or adaptations of the present disclosure that follow the general principles of the present disclosure and include common knowledge or techniques in the technical field not disclosed by the present disclosure. The specification and examples are to be regarded as exemplary only, with the true scope and spirit of the disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

What is claimed is:

1. A method for processing a video, comprising:
determining a plurality of candidate commodities that will be recommended to a user based on attribute information of the user and attribute information of a plurality of commodities to be promoted;
sending recommendation information including the plurality of candidate commodities to a user terminal;
receiving a selection instruction for a target commodity sent by the user terminal and a video created by the user for the target commodity, wherein the target commodity is selected by the user from the plurality of candidate commodities based on the recommendation information; and
creating a promotional video by synthesizing sales information of the target commodity with the video.

2. The method according to claim 1, wherein said creating the promotional video by synthesizing the sales information of the target commodity with the video comprises:
acquiring the sales information of the target commodity, a display time and a display position of the sales information in the video;
determining a display mode of the target commodity in the video based on the sales information, the display time and the display position; and
creating the promotional video based on the display mode.

3. The method according to claim 2, wherein said acquiring the display time of the sales information of the target commodity in the video comprises:
acquiring an appearance time of the target commodity in the video, determining a start display time of the target commodity based on the appearance time, and determining the display time based on the start display time and an end time of the video; or
acquiring a start time and an end time of the video, and determining the display time based on the start time and the end time; or
acquiring a preset start display time and a preset end display time of the target commodity in the video, and determining the display time based on the preset start display time and the preset end display time.

4. The method according to claim 2, wherein said acquiring the display time of the sales information of the target commodity in the video comprises:
obtaining an association degree between the target commodity and each frame image in the video by analyzing the attribute information of the target commodity and content information of the video;
selecting multiple frame images of which the association degrees satisfy a preset association degree condition; and
determining the display time based on respective appearance time of the multiple frame images.

5. The method according to claim 4, wherein said determining the display time based on respective appearance time of the multiple frame images comprises:
determining the display time based on the appearance time of a first target frame image in which the target commodity is appeared for a first time among the multiple frame images; or
determining the display time based on the appearance time of a second target frame image with a highest association degree among the multiple frame images.

6. The method according to claim 1, wherein said creating the promotional video by synthesizing the sales information of the target commodity with the video comprises:
in response to content of the target commodity being consistent with the content of the video, creating the promotional video by synthesizing the sales information of the target commodity with the video.

7. The method according to claim 1, wherein the attribute information of the user comprises basic attribute information of the user and a type of historical short videos uploaded by the user;
wherein determining the plurality of candidate commodities that will be recommended to the user based on the attribute information of the user and the attribute information of the plurality of commodities comprises:
obtaining a matching score between the user and each of the plurality of commodities based on the basic attribute information of the user, the type of the historical short videos uploaded by the user, and the attribute information of the plurality of commodities; and
determining the plurality of candidate commodities based on commodities of which the matching scores satisfy a preset score conditions.

8. The method according to claim 7, wherein the attribute information of the user further comprises a number of times that the user browses commodities;
wherein determining the plurality of candidate commodities that will be recommended to the user based on the attribute information of the user and the attribute information of the plurality of commodities comprises:
determining preference information of the user based on the basic attribute information of the user, the type of historical short videos uploaded by the user, and a number of times that the user browses commodities;
determining a similarity between the user and each of the plurality of commodities based on the preference information of the user and the attribute information of the plurality of commodities; and
selecting the commodities of which the similarities satisfy a preset similarity condition, and determining the plurality of candidate commodities based on the selected commodities.

9. The method according to claim 7, wherein the attribute information of the user further comprises attribute information of commodities that have been promoted by the user;
wherein said determining the plurality of candidate commodities that will be recommended to the user based on the attribute information of the user and the attribute information of the plurality of commodities to be promoted comprises:
matching a basic attribute tag based on the basic attribute information of the user;
matching a video type tag based on the type of historical short videos uploaded by the user;
matching a first commodity attribute tag based on attribute information of commodities that have been promoted by the user;
matching a second commodity attribute tag based on the attribute information of the plurality of commodities to be promoted;
determining a user feature vector based on the basic attribute tag, the video type tag and the first commodity attribute tag, and determining respective feature vectors of the plurality of commodities to be promoted based on the second commodity attribute tag;
calculating respective distances between the user feature vector and a plurality of feature vectors of the commodities to be promoted by using a content-based recommendation algorithm;
selecting the commodities to be promoted of which the distances satisfy a preset distance condition; and
determining the plurality of candidate commodities based on the selected commodities.

10. An electronic device, comprising:
a processor;
a memory for storing instructions executable by the processor;
wherein the processor is configured to:
determine a plurality of candidate commodities that will be recommended to a user based on attribute information of the user and attribute information of a plurality of commodities to be promoted;
send recommendation information including the plurality of candidate commodities to a user terminal;
receive a selection instruction for a target commodity sent by the user terminal and a video created by the user for the target commodity, wherein the target commodity is selected by the user from the plurality of candidate commodities based on the recommendation information; and
create a promotional video by synthesizing sales information of the target commodity with the video.

11. The electronic device of claim 10, wherein the processor is configured to:
acquire the sales information of the target commodity, a display time and a display position of the sales information in the video;
determine a display mode of the target commodity in the video based on the sales information, the display time and the display position; and
create the promotional video based on the display mode

12. The electronic device of claim 11, wherein the processor is configured to:
acquire an appearance time of the target commodity in the video, determine a start display time of the target commodity based on the appearance time, and determine the display time based on the start display time and an end time of the video; or
acquire a start time and an end time of the video, and determine the display time based on the start time and the end time; or
acquire a preset start display time and a preset end display time of the target commodity in the video, and determine the display time based on the preset start display time and the preset end display time.

13. The electronic device of claim 11, wherein the processor is configured to:
obtain an association degree between the target commodity and each frame image in the video by analyzing the attribute information of the target commodity and content information of the video;
select multiple frame images of which the association degrees satisfy a preset association degree condition; and
determine the display time based on respective appearance time of the multiple frame images.

14. The electronic device of claim 13, wherein the processor is configured to:
determine the display time based on the appearance time of a first target frame image in which the target commodity is appeared for a first time among the multiple frame images; or
determine the display time based on the appearance time of a second target frame image with a highest association degree among the multiple frame images.

15. The electronic device of claim 10, wherein the processor is configured to:
in response to the content of the target commodity being consistent with the content of the video, create the promotional video by synthesizing the sales information of the target commodity with the video.

16. The electronic device of claim 10, wherein the attribute information of the user comprises basic attribute information of the user and a type of historical short videos uploaded by the user;
wherein the processor is configured to:
obtain a matching score between the user and each of the plurality of commodities based on the basic attribute information of the user, the type of the historical short videos uploaded by the user, and the attribute information of the plurality of commodities; and
determine the plurality of candidate commodities based on commodities of which the matching scores satisfy a preset score conditions.

17. The electronic device according to claim 16, wherein the attribute information of the user further comprises a number of times that the user browses commodities;
wherein the processor is configured to:
determine preference information of the user based on the basic attribute information of the user, the type of historical short videos uploaded by the user, and the number of times that the user browses commodities;
determine a similarity between the user and each of the plurality of commodities based on the preference information of the user and the attribute information of the plurality of commodities; and
select the commodities of which the similarities satisfy a preset similarity condition, and determine the plurality of candidate commodities based on the selected commodities.

18. The electronic device according to claim 16, wherein the attribute information of the user further comprises attribute information of the of commodities that have been promoted by the user;
wherein the processor is configured to:
match a basic attribute tag based on the basic attribute information of the user;
match a video type tag based on the type of historical short videos uploaded by the user;
match a first commodity attribute tag based on attribute information of commodities that have been promoted by the user;
match a second commodity attribute tag based on the attribute information of the plurality of commodities to be promoted;
determine a user feature vector based on the basic attribute tag, the video type tag and the first commodity attribute tag, and determine respective feature vectors of the plurality of commodities to be promoted based on the second commodity attribute tag;
calculate respective distances between the user feature vector and a plurality of feature vectors of the commodities to be promoted by using a content-based recommendation algorithm;
select the commodities to be promoted of which the distances satisfy a preset distance condition; and
determine the plurality of candidate commodities based on the selected commodities.

19. A storage medium, when instructions in the storage medium are executed by a processor of an electronic device, the electronic device is enabled to execute a method for processing a video,
wherein, the method for processing the video comprises:
determining a plurality of candidate commodities that will be recommended to a user based on attribute information of the user and attribute information of a plurality of commodities to be promoted;
sending recommendation information including the plurality of candidate commodities to a user terminal;
receiving a selection instruction for a target commodity sent by the user terminal and a video created by the user for the target commodity, wherein the target commodity is selected by the user from the plurality of candidate commodities based on the recommendation information; and
creating a promotional video by synthesizing sales information of the target commodity with the video.
